(19) United States
(12) Patent Application Publication
(10) Pub. No.: US 2023/0077746 A1
(43) Pub. Date: Mar. 16, 2023

(54) Pod Insert for Pod Gardening Systems

(71) Applicants: Julia Flanary, Longview, WA (US); Jodie Merrill, Kelso, WA (US); Dennis Flanary, II, Longview, WA (US)

(72) Inventors: Julia Flanary, Longview, WA (US); Jodie Merrill, Kelso, WA (US); Dennis Flanary, II, Longview, WA (US)

(21) Appl. No.: 17/578,793

(22) Filed: Jan. 19, 2022

Related U.S. Application Data
(60) Provisional application No. 63/244,444, filed on Sep. 15, 2021.

(51) Int. Cl. A01G 7/04; A01G 9/029; A01G 27/06

(52) U.S. Cl. CPC A01G 7/045; A01G 9/0291; A01G 27/06

(57) ABSTRACT

The present invention relates to a novel insert for covering empty or unused pods of an indoor or pod gardening system. The pod insert includes an insert component that is placed inside a pod to fill empty space and a decorative or grasping topper element component that is placed on top of the insert to cover the pod. The grasping topper element is fastened to the insert for securing the topper to cover the pod. In one variant of the insert, the topper includes a weighted base that can be placed on top of the empty pod thereby eliminating need of fastening the topper. The decorative or grasping topper element can come in a variety of designs and can have an illumination source and a solar panel. The decorative insert effectively prevents algae, moss, and bacteria from growing within the pod while providing aesthetic appeal to the system.

### CROSS-REFERENCE TO RELATED APPLICATION

The present application claims priority to, and the benefit of, U.S. Provisional Application No. 63/244,444, which was filed on Sep. 15, 2021 and is incorporated herein by reference in its entirety.

### FIELD OF THE INVENTION

The present invention relates generally to the field of indoor or pod gardening systems. More specifically, the present invention relates to a novel insert for empty or unused indoor or pod gardening system pods. The insert is accommodated in the empty pod and a decorative or grasping topper element is removably attached on the top of the insert. The insert therefore improves the look of the insert while effectively preventing algae, moss, and bacteria from growing within the pod. The decorative insert may include gnomes, fairies, frogs, and numerous other decorations. Accordingly, the present disclosure makes specific reference thereto. Nonetheless, it is to be appreciated that aspects of the present invention are also equally applicable to other like applications, devices and methods of manufacture.

### BACKGROUND

By way of background, flowers and other plants grow in the outdoors where there is an abundance of water and sunlight. However, for people who do not have access to outdoor gardening, indoor or pod gardening systems are deployed to grow flowers and plants. Technologies such as hydroponic gardening can be used in such systems for growing flowers and plants. Generally, the indoor or pod gardening systems have a plurality of pods that are used for growing various types of flowers, plants, seedlings and others.

A common occurrence with indoor or pod gardening systems is that some of the pods remains unused or empty without any flower or plant grown in the pods. Over time, such pods can begin to house algae, moss and other debris. Such pods may also attract insects which can cause damage to the flowers and plants growing in other pods. Such pods can discolor with time and may not remain useful for growing plants and flowers. People desire an aesthetic and effective way to cover such unused or empty pods without affecting other plants and flowers growing in the system.

Also, empty pods reduce the aesthetic appeal of the system and people desire to cover such pods in a way that the cover can enhance their décor in addition to protecting flowers and plants of other pods.

Therefore, there exists a long felt need in the art for a pod cover for indoor gardening pods that can effectively prevent algae, moss and bacteria from growing within the pods. There is also a long felt need in the art for an insert for unused indoor gardening pod systems that is decorative and maintains aesthetic appeal of the pod systems. Additionally, there is a long felt need in the art for a cover that can effectively cover empty pods of indoor or pod gardening systems. Moreover, there is a long felt need in the art for a pod cover that covers a pod and protects it from insects. Further, there is a long felt need in the art for a pod cover that does not affect growth of plants and flowers growing in other pods. Finally, there is a long felt need in the art for a pod cover that can be removably placed over an empty pod to cover the pod and offers a way to decorate unused pods of an indoor or pod gardening system to improve its overall aesthetic and prevention from accumulation of dirt and pathogens.

The subject matter disclosed and claimed herein, in one embodiment thereof, comprises a unique decorative insert for unused indoor gardening pod systems. The decorative insert includes an insert for filling the empty pod area to prevent algae and moss buildup. A decorative or grasping topper element is placed on the insert to cover the pod from the top. The decorative or grasping topper element can come as gnomes, fairies, frogs, and numerous other decorations. The decorative insert offers a way to decorate unused spaces on the system to improve the overall aesthetic.

In this manner, the decorative insert for empty indoor or pod gardening system pods of the present invention accomplishes all of the forgoing objectives and provides users with an insert having a decorative or grasping topper element. The insert is configured to be placed in an empty pod with the decorative or grasping topper element removably attached to the insert. The decorative or grasping topper element provides aesthetic appeal and covers the pod. The insert fills the unused pot to prevent algae and moss build-up, thereby protecting from pathogens.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a decorative insert for indoor or pod gardening system pods. The decorative insert is configured to cover empty pods, which are not presently being used for growing plants and flowers. The decorative insert further comprising an insert, the insert is configured to be placed inside an empty pod to fill the empty space, the insert having a solid body with a bottom surface and a top screwing periphery, a decorative or grasping topper element, the grasping topper element having a circular or mounting threaded base, the circular or mounting threaded base configured to screw to the top screwing periphery such that the grasping topper element is placed on the insert to cover the empty pod in an aesthetic manner wherein the decorative or grasping topper element is visible from outside. The decorative insert protects the empty pods from accumulation of algae, moss and pathogens.

In yet another embodiment, the insert includes a biodegradable soil capsule that can be used for growing plants and flowers.

In yet another embodiment, a decorative pod insert for protecting unused pods of an indoor or pod gardening system is disclosed. The decorative pod insert includes a weighted circular or mounting threaded base, a telescoping pipe and a photo frame. The weighted circular or mounting threaded base is positioned on a top surface of the system to cover an unused pod and protect it from algae and moss depositing in the unused pod.

In yet another embodiment, the photo frame can be used for accommodating a photograph.

In yet another embodiment, a method for covering empty pods of an indoor or pod gardening system is disclosed. The method includes the steps of inserting an insert into an empty pod wherein the insert is dimensioned to fill empty space of the pod, fastening a decorative or grasping topper element to the lip of the insert such that the decorative or grasping topper element is positioned on top of the insert, and replacing the decorative or grasping topper element with a topper of another design.

In yet another embodiment, the decorative or grasping topper element can be gnome shaped, frog shaped or any other animal shaped.

In yet another embodiment, the decorative or grasping topper element includes an illumination source and a solar panel for providing power to the illumination source.

In yet another embodiment, the decorative insert does not affect plants and flowers growing in other pods of an indoor growing system.

In yet another embodiment, the topper provides aesthetic appeal of the indoor or pod gardening system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a decorative insert of the present invention for unused pods of an indoor or pod gardening system in accordance with the disclosed architecture;

FIG. 2 illustrates an exemplary indoor gardening pod system having an empty gardening pod covered with the decorative insert of FIG. 1 in accordance with the disclosed architecture;

FIG. 3 illustrates a perspective view showing another indoor gardening pod system with a plurality of plants and a plurality of decorative inserts having various designs installed in the pods in accordance with the disclosed architecture;

FIG. 4 illustrates a perspective view showing a variant of the decorative insert of the present invention placed in an empty pod of the indoor or pod gardening system in accordance with the disclosed architecture;

FIG. 5 illustrates a perspective view of the gnome shaped decorative insert of the present invention in accordance with the disclosed architecture; and

FIG. 6 illustrates a flow diagram showing exemplary steps performed in installing the decorative insert in an empty pod in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a cover for indoor gardening pods that can effectively prevent algae, moss and bacteria from growing within the pods. There is also a long felt need in the art for an insert for unused indoor gardening pod systems that is decorative and maintains aesthetic appeal of the pod systems. Additionally, there is a long felt need in the art for a cover that can effectively cover empty or unused pods of indoor or pod gardening systems. Moreover, there is a long felt need in the art for a pod cover that covers a pod and protects from insects. Further, there is a long felt need in the art for a pod cover that does not affect growth of plants and flowers growing in other pods. Finally, there is a long felt need in the art for a pod cover that can be removably placed over an empty pod to cover the pod and offers a way to decorate unused pods of an indoor or pod gardening system to improve its overall aesthetic and prevention from accumulation of dirt and pathogens.

The present invention, in one exemplary embodiment, is a novel decorative insert for indoor or pod gardening system pods. The decorative insert is configured to cover empty pods which are not used for growing plants and flowers. The decorative insert features a tapered insert, the insert is configured to be placed inside an empty pod to fill the empty space, the insert having a solid body with a bottom surface and a top screwing periphery, a decorative or grasping topper element, the decorative or grasping topper element having a circular or mounting threaded base, the circular base configured to screw to the top screwing periphery such that the decorative or grasping topper element is placed on the insert to cover the empty pod in an aesthetic manner wherein the decorative or grasping topper element is visible from outside. The decorative insert protects the empty pods from accumulation of algae, moss and pathogens.

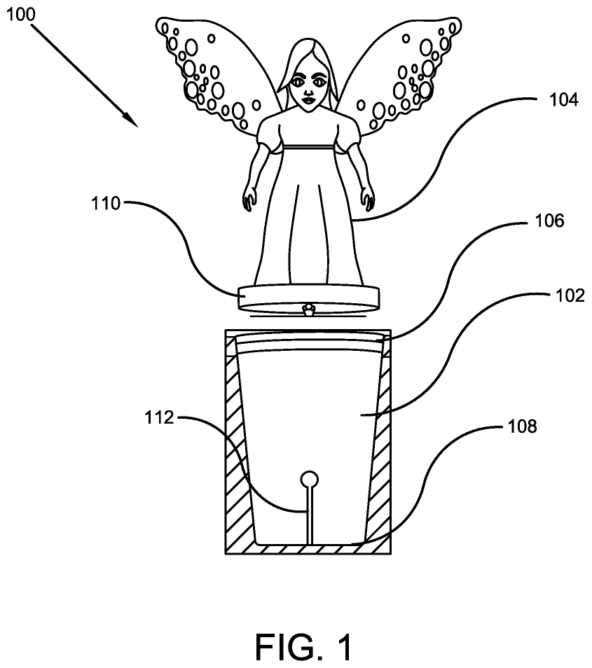

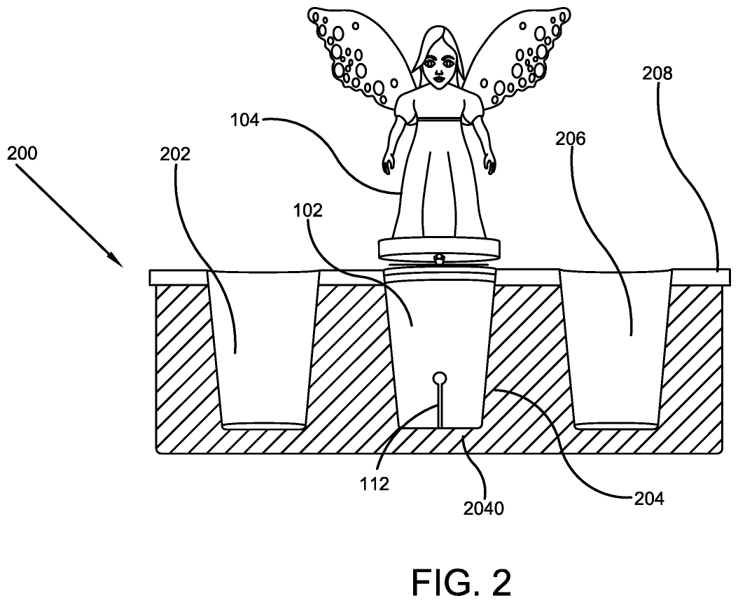

Referring initially to the drawings, FIG. 1 illustrates a perspective view of one potential embodiment of decorative insert of the present invention for unused pods of an indoor or pod gardening system in accordance with the disclosed architecture. The decorative insert 100 includes an insert 102 that is configured to be placed inside an empty pod as best shown in FIG. 2. The insert 102 is shown in an exemplary circular tapered shape but can be of any geometric shape to fit into pods of various shapes and sizes. Although not illustrated, it is to be appreciated that the insert can be, for example, octagonal, rectilinear, pentagonal, et. al. The insert 102 fills the empty pod and thereby does not let water/moisture to deposit in the pod, and thus prevents algae, moss, and bacteria from growing within the pod. Preferably, the insert 102 includes a solid body with a bottom surface 108 and a top screw or threaded periphery 106. The bottom surface 108 is placed on the base of the pod and the top screw or threaded periphery 106 is used for attaching a decorative or grasping topper element 104 to the insert 102. The insert 102 is dimensioned such that the top screw or threaded periphery 106 is positioned either along the top surface or just above the top surface of the indoor or pod gardening system.

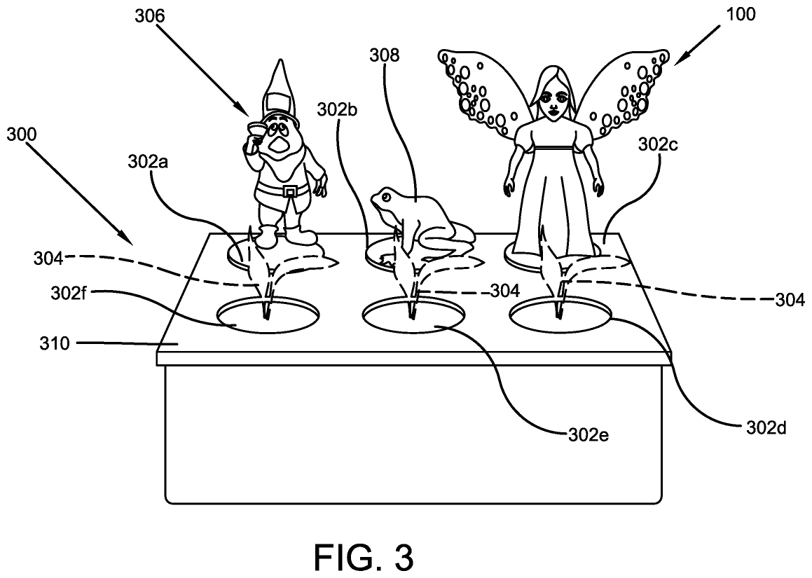

The grasping topper element 104 is configured to be removably attached to the insert 102 such that the grasping topper element 104 is placed on top of the insert 102. The decorative or grasping topper element 104 is visually exposed and maintain the aesthetic appeal of the indoor or pod gardening system as best shown in FIGS. 2 and 3. The grasping topper element 104 includes a circular or mounting threaded base 110 that is configured to be screwed to the top threaded periphery 106 of the insert 102 for attaching the topper 104 to the insert 102. Alternatively, the decorative topper 104 and the insert 102 can be attached to each other using a magnetic fastener.

It should be understood that the decorative or grasping topper element 104 can be replaced with another topper having a different design as per the preference of a user and can be used for enhancing decor and aesthetic appeal of the indoor or pod gardening system to which the decorative insert 100 is attached. In the present embodiment, the decorative or grasping topper element 104 and the insert 102 are separably attached to each other. However, alternatively, the decorative or grasping topper element and the insert 102 can be integrated as a single unit.

In one embodiment, the insert 102 may be filled with a soil capsule that is 100% biodegradable so that the insert 102 can also be used for growing a plant or flower inside a pod. Further, the insert 102 may have a wick 112 for drawing water and providing same to a plant or flower. The decorative topper 104 can be removed in such cases and a plant or flower can be grown in the soil capsule.

FIG. 2 illustrates an exemplary indoor gardening pod system 200 having an empty gardening pod 204 covered with the decorative insert 100 of FIG. 1 in accordance with the disclosed architecture. The indoor gardening pod system 200 is configured to grow flowers and other plants for indoors using a state-of-the-art technique such as hydroponic technique. As shown, the system 200 includes a plurality of empty or unused pods 202,204,206 that are not used for growing flowers or plants and can attract moss and algae. Further, moisture and water present in the empty pods can attract insects which can be detrimental to flowers and plants growing in other pods. Therefore, for covering the exemplary empty pod 204, the insert 102 is inserted in the empty pod 204. The insert 102 completely occupies and fills the pod 204 with the bottom surface 108 resting on the pod base 2040 and the top threaded periphery 106 is accessible to a user from the top surface 208 of the system 200 to screw the circular or mounting threaded base 110 to the top threaded periphery 106.

The decorative topper 104 is removably fastened to the insert 102 and rests on the top surface 208 of the system 200 such that the decorative or grasping topper element 104 is visually exposed.

FIG. 3 illustrates a perspective view showing another indoor gardening pod system 300 with a plurality of plants and a plurality of decorative inserts having various designs installed in the pods in accordance with the disclosed architecture. As shown, in the present embodiment, the pod system 300 includes six pods referenced through numerals 302a-f. The pods 302a-c are empty and are not used for growing a plant or flower. The pods 302d-f are used for growing plants 304. As the pods 302a-c are not being used and remain empty, they are covered with decorative inserts having a variety of designs of decorative or grasping topper elements for both protection from algae and moss and providing aesthetic appeal.

As illustrated, the pod 302a is covered by the gnome shaped decorative insert 306, the pod 302b is covered by the frog shaped decorative insert 308 and the pod 302c is covered by the indoor gardening pod decorative insert 100. It should be understood that there may be no limit on designs of the decorative or grasping topper elements of the inserts. Further, as illustrated in FIGS. 1 and 2, each decorative insert 100,306,308 includes an insert which is placed inside the pods and only the decorative or grasping topper elements are visible from outside. Moreover, the decorative or grasping topper elements can be removed and replaced with decorative or grasping topper elements of other designs.

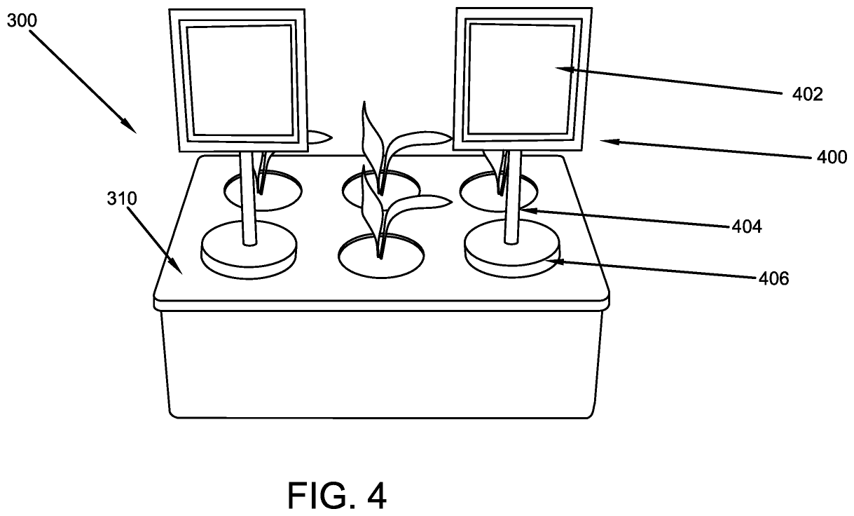

FIG. 4 illustrates a perspective view showing a variant of the decorative insert of the present invention placed in an empty pod of the indoor or pod gardening system in accordance with the disclosed architecture. In the present embodiment, the pod decorative insert 400 includes a decorative or grasping topper element 402 in the shape of a photo frame configured to store a photograph. The decorative insert includes a telescoping pipe 404 that can be extended or retracted to increase the vertical height of the decorative or grasping topper element 402. In the present embodiment, for securely placing the topper 402 to cover the empty pod, the decorative insert 400 includes a weighted circular or mounting threaded base 406 that is placed on the top surface 310 of the system 300. The weighted circular base 406 is dimensioned to cover the opening of the pod and stabilizes the decorative insert 400. The base 406 does not allow the insert 400 to easily tilt and fall. Further, the base 406 creates a vacuum inside an empty pod and thus prevents algae and moss to accumulate in the pod.

For growing a plant or flower in an empty pod, the decorative insert 400 can be easily removed from the top of the pod and can also be replaced with a decorative of another design.

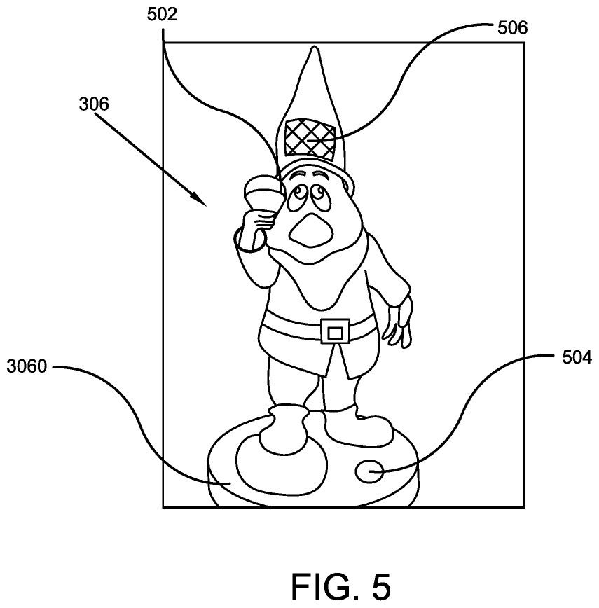

FIG. 5 illustrates a perspective view of the gnome shaped decorative insert 306 of the present invention in accordance with the disclosed architecture. The gnome shaped decorative insert 306 includes an LED illumination source 502 that can be activated by pressing a push button 504 placed on the cap/base 3060. The push button 504 can also be used for deactivating the LED 502.

The insert 306 includes a solar panel 506 for absorbing solar energy and converting it into electrical energy for illuminating LED 502. It should be understood that the illumination source in various forms can be integrated into various decorative inserts of the present invention.

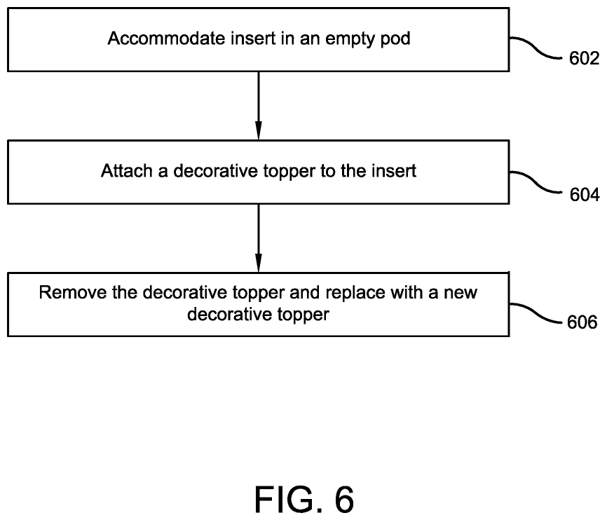

FIG. 6 illustrates a flow diagram showing exemplary steps performed in installing decorative insert in an empty pod in accordance with the disclosed architecture. As shown, initially, a pod insert of the decorative insert is placed in an empty pod to fill the empty area of the pod (Step 602). Then, a desired decorative or grasping topper element is fastened to the insert through a fastening means (Step 604). Accordingly, the decorative insert covers and protects the empty pod. Thereafter, based on preference of a user, the decorative or grasping topper element can be removed and replaced with a new topper or can be used for installing plants or flowers (Step 606).

It should be appreciated that users can insert the decorative inserts into each pod and display a decorative topper while growing flowers and other plants. Further, the invention offers numerous different colors, styles, and designs for the toppers such as gnomes, fairies, animals and much more.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “decorative insert”, “indoor gardening pod decorative insert”, “pod insert”, and “pod decorative insert” are interchangeable and refer to the indoor gardening pod decorative insert 100,306,308,400 of the present invention.

Notwithstanding the forgoing, the indoor gardening pod decorative insert 100,306,308,400 of the present invention can be of any suitable size and configuration as is known in the art without affecting the overall concept of the invention, provided that it accomplishes the above-stated objectives. One of ordinary skill in the art will appreciate that the size, configuration and material of the indoor gardening pod decorative insert 100, 306, 308, 400 as shown in the FIGS. are for illustrative purposes only, and that many other sizes and shapes of the indoor gardening pod decorative insert 100, 306, 308, 400 are well within the scope of the present disclosure. Although the dimensions of the indoor gardening pod decorative inserts 100, 306, 308, 400 are important design parameters for user convenience, the indoor gardening pod decorative inserts 100, 306, 308, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plant pod insert for a pod gardening system comprising:
said plant pod insert for placing inside an empty plant pod, wherein said plant pod insert includes a tapered insertion first end and a planar bottom surface;
wherein said plant pod insert circumscribes substantially said empty plant pod interior surfaces for prohibiting water from depositing in said empty plant pod;
wherein said plant pod insert further includes a threaded periphery top end;
a topper section including a mounting threaded base, wherein said mounting threaded base includes a grasping topper element extending thereabove;
wherein said threaded periphery threadingly engageable with said mounting threaded base; and
wherein said grasping topper element extends above said threaded periphery.

2. The plant pod insert of claim 1, wherein said threaded periphery extends along a top surface of the pod gardening system.

3. The plant pod insert of claim 1, wherein said threaded periphery extends above a top surface of the pod gardening system.

4. The plant pod insert of claim 1, wherein said grasping topper element removably attached to said plant pod insert.

5. The plant pod insert of claim 1, wherein a first said grasping topper element is selectively exchangeable with at least a second said grasping topper element.

6. The plant pod insert of claim 1, wherein said grasping topper element is integrated with said plant pod insert.

7. The plant pod insert of claim 1, wherein said plant pod insert comprises a biodegradable soil capsule insert for growing a plant therein.

8. The plant pod insert of claim 7, wherein said biodegradable soil capsule insert incudes a wick for drawing water to an interior of said biodegradable soil capsule.

9. A plant pod insert for a pod gardening system comprising:
said plant pod insert for placing inside an empty plant pod, wherein said plant pod insert includes a weighted base and a telescoping pipe extending thereabove;
a topper section attached to a terminal end of said telescoping pipe; and
wherein said weighted base covers a top opening of said empty plant pod, wherein said weighted creates a vacuum inside said empty plant pod.

10. The plant pod insert of claim 9, wherein said weighted base comprises a circular base extending above a top surface of the pod gardening system.

11. The plant pod insert of claim 10, wherein said topper section includes a photo frame.

12. The plant pod insert of claim 11, wherein a first said topper section is selectively exchangeable with at least a second said topper section.

13. A plant pod insert for a pod gardening system comprising:
said plant pod insert for placing inside an empty plant pod;
wherein said plant pod insert circumscribes substantially said empty plant pod interior surfaces for prohibiting water from depositing in said empty plant pod;
wherein said plant pod insert further includes a threaded periphery top end;
a topper section including a mounting threaded base, wherein said mounting threaded base includes said topper section extending thereabove;
wherein said threaded periphery threadingly engageable with said mounting threaded base;
wherein said topper section extends above said threaded periphery; and
said topper section includes an illumination source for illuminating said topper section.

14. The plant pod insert of claim 13, wherein said threaded periphery extends along a top surface of the pod gardening system.

15. The plant pod insert of claim 13, wherein said topper section includes a solar panel for powering said illumination source.

16. The plant pod insert of claim 15, wherein said topper section removably attached to said plant pod insert.

17. The plant pod insert of claim 16, wherein a first said topper section is selectively exchangeable with at least a second said topper section.

18. The plant pod insert of claim 15, wherein said topper section is integrated with said plant pod insert.

19. The plant pod insert of claim 17, wherein said plant pod insert comprises a biodegradable soil capsule insert for growing a plant therein.

20. The plant pod insert of claim 19, wherein said biodegradable soil capsule insert incudes a wick for drawing water to an interior of said biodegradable soil capsule.
